(19) United States
(12) Patent Application Publication
(10) Pub. No.: US 2026/0016634 A1
(43) Pub. Date: Jan. 15, 2026

(54) PWB POLARIZATION ROTATION

(71) Applicant: Luminar Technologies, Inc., Orlando, FL (US)

(72) Inventor: Gordon Barbour Morrison, Summerland, CA (US)

(21) Appl. No.: 19/242,753

(22) Filed: Jun. 18, 2025

Related U.S. Application Data
(60) Provisional application No. 63/663,025, filed on Jun. 21, 2024.

(51) Int. Cl. G02B 6/126; G02B 6/12

(52) U.S. Cl. CPC G02B 6/126; G02B 2006/12135

(57) ABSTRACT

An aspect of the disclosure is related to an apparatus consisting of a first chip including a first waveguide and a second chip including a second waveguide. The apparatus further includes a medium to couple the first waveguide with the second waveguide. The first plane of the first chip is arranged to be perpendicular to a second plane of the second chip to enable a polarization rotation.

### BACKGROUND

### Technical Field

The present disclosure generally relates to waveguides, and more particularly, to achieving polarization rotation between two optical chips (including optical circuits) coupled via photonic wire bonding (PWB).

### Related Art

Waveguide technology stands as a cornerstone in diverse fields, particularly within the domains of optical communication and signal processing. The efficient transmission of electromagnetic waves along predefined paths is pivotal for the development of high-performance devices. While existing methods for connecting waveguides have proven effective, they encounter challenges when confronted with polarization rotation in transmitted signals. Achieving a seamless and dependable connection while accommodating polarization rotation becomes paramount in optimizing the performance of optical systems. Hence, there exists a compelling need in the waveguide technology domain for an innovative solution that adeptly addresses the complexities of waveguide connection while efficiently managing polarization changes.

### SUMMARY

In some aspects, the subject disclosure is related to an apparatus consisting of a first chip including a first waveguide and a second chip including a second waveguide. The apparatus further includes a medium to couple the first waveguide with the second waveguide. The first plane of the first chip is arranged to be perpendicular to a second plane of the second chip to enable a polarization rotation.

Another aspect of the disclosure is related to an apparatus consisting of a first chip including a first waveguide and a second chip including a second waveguide. An optical wire bond is used to couple the first waveguide with the second waveguide. The first chip is placed on a first surface of a support structure. The second chip is placed on a second surface of the support structure, and a first electric field of electromagnetic waves within the first waveguide has a different polarization than a second electric field of the electromagnetic waves within the second waveguide.

Yet another aspect of the subject disclosure is directed to a method consisting of placing a first chip including a first waveguide on a first surface of a support structure and placing a second chip including a second waveguide on a second surface of the support structure, The method further includes optically coupling the first chip with the second chip using an optical medium. A first electric field of electromagnetic waves within the first waveguide has a first polarization and a second electric field of the electromagnetic waves within the second waveguide has a second polarization rotated with respect to the first polarization.

### BRIEF DESCRIPTION OF THE DRAWINGS

To easily identify the discussion of any particular element or act, the most significant digit or digits in a reference number refer to the figure number in which that element is first introduced.

FIG. 1 is a schematic diagram illustrating an example of coupling two optical chips with polarization rotation, according to certain aspects of the disclosure,

FIG. 2 is a schematic diagram illustrating an example of a setup for coupling two optical chips with polarization rotation, according to certain aspects of the disclosure.

FIG. 3 is a schematic diagram illustrating an example of a setup for coupling, via a PWB, two optical chips with polarization rotation, according to certain aspects of the disclosure.

FIG. 4 is a schematic diagram illustrating an example of a setup for coupling, via a PWB, two optical chips with polarization rotation, according to certain aspects of the disclosure.

FIG. 5 is a schematic diagram illustrating an example of a coupling between two optical chips using PWB to achieve polarization rotation, according to certain aspects of the disclosure.

FIG. 6 is a schematic diagram illustrating an example of a setup for coupling two optical chips with polarization rotation with independent temperature control, according to certain aspects of the disclosure.

FIG. 7 is a schematic diagram illustrating an example of a method 700 of configuring an arrangement of two optical chips to enable polarization rotation, according to certain aspects of the disclosure.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

In the following detailed description, numerous specific details are set forth to provide a full understanding of the present disclosure. It will be apparent, however, to one ordinarily skilled in the art, that embodiments of the present disclosure may be practiced without some of these specific details. In other instances, well-known structures and techniques have not been shown in detail so as not to obscure the disclosure. Embodiments as disclosed herein will be described with the description of the attached figures.

In the following detailed description, methods of achieving polarization rotation between two optical chips coupled via an optical medium is described.

In certain aspects of the subject technology, the limitations associated with connecting waveguides and effectively managing polarization changes within optical systems (e.g., chips) are mitigated. The disclosed solution proposes a method that ensures a robust and adaptable connection between waveguides while simultaneously tackling polarization variations. Employing state-of-the-art materials and design principles, the disclosure provides a versatile solution that enhances overall efficiency and reliability in optical communication and signal processing systems. The amalgamation of unique elements within the present disclosure seeks to establish a new benchmark for waveguide connection methods, making a substantial contribution to advancing optical technologies across various applications.

In some implementations, the disclosed apparatus consists of a first chip including a first waveguide and a second chip including a second waveguide.

In one or more implementations, the apparatus of the subject technology further includes a medium to couple the first waveguide with the second waveguide.

In some implementations, the first plane of the first chip is arranged to be perpendicular to a second plane of the second chip to enable a polarization rotation.

In one or more implementations, the polarization rotation comprises a 90-degree rotation of a second electric field of electromagnetic waves within the second waveguide relative to a first electrical field of the electromagnetic waves within the first waveguide.

In some implementations, the medium comprises an optical wire bond configured to conserve a first polarization within the first waveguide.

In one or more implementations, the first chip comprises a first semiconductor chip including a first optical circuit and the second chip comprises a second semiconductor chip including a second optical circuit.

In some implementations, the medium is configured to couple the first optical circuit with the second optical circuit.

In one or more implementations, the first waveguide and the second waveguide are supported by using an alignment shim.

In some implementations, the alignment shim comprises a first surface perpendicular to a second surface.

In one or more implementations, the first chip and the second chip are attached to the first surface and the second surface of the alignment shim, respectively.

In some implementations, the apparatus comprises a thermoelectric-cooler (TEC) layer configured to control a temperature of the first chip and the second chip.

In one or more implementations, the apparatus comprises a first TEC layer and a second TEC layer configured to control temperatures of the first chip and the second chip, independently.

In some implementations, the disclosure is related to an apparatus consisting of a first chip including a first waveguide and a second chip including a second waveguide.

In some implementations, an optical wire bond is used to couple the first waveguide with the second waveguide.

In one or more implementations, the first chip is placed on a first surface of a support structure.

In one or more implementations, the second chip is placed on a second surface of the support structure, and a first electric field of electromagnetic waves within the first waveguide has a different polarization than a second electric field of the electromagnetic waves within the second waveguide.

In one or more implementations, a second polarization of the second electric field is rotated with respect to a first polarization of the first waveguide by 90 degrees.

In some implementations, the first surface and the second surface of the support structure are configured to be perpendicular to one another to allow a 90-degree polarization rotation.

In one or more implementations, the first surface and the second surface of the support structure are configured to be on a same plane.

In some implementations, a polarization rotation between the first electric field of electromagnetic waves and the second electric field of the electromagnetic waves is enabled by the optical wire bond.

In one or more implementations, the apparatus further comprises a TEC layer configured to control temperatures of the first chip and the second chip.

In some implementations, the apparatus further comprises a first TEC layer and a second TEC layer configured to control temperatures of the first chip and the second chip, independently.

In one or more implementations, the subject disclosure is directed to a method consisting of placing a first chip including a first waveguide on a first surface of a support structure and placing a second chip including a second waveguide on a second surface of the support structure.

In some implementations, the method further includes optically coupling the first chip with the second chip using an optical medium.

In one or more implementations, a first electric field of electromagnetic waves within the first waveguide has a first polarization and a second electric field of the electromagnetic waves within the second waveguide has a second polarization rotated with respect to the first polarization.

In one or more implementations, a polarization rotation associated with the second electric field with respect to the first electric field of electromagnetic waves is achieved via the optical medium, wherein the optical medium comprises an optical wire bond.

In some implementations, a polarization rotation associated with the second electric field of electromagnetic waves with respect to the first electric field of the electromagnetic waves is achieved by the second surface being perpendicular to the first surface.

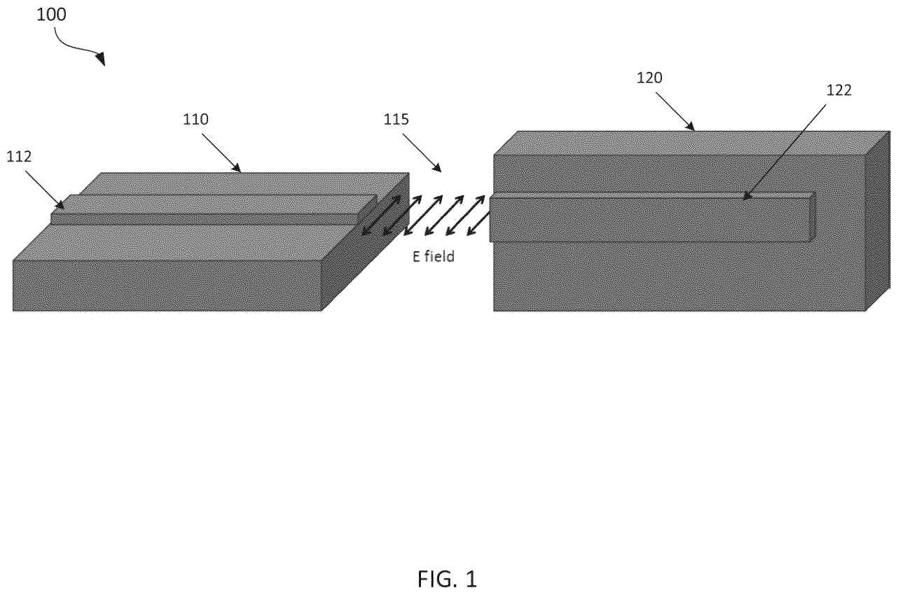

Turning now to the figures, FIG. 1 is a schematic diagram illustrating an example of coupling 100 of two optical chips 110 and 120 with polarization rotation, according to certain aspects of the disclosure. In some implementations, the first optical chip 110 and the second chip 120 are semiconductor chips made of a semiconductor and can include, for example, gallium arsenide (GaAs), indium phosphite (InP), gallium nitride (GaN), thin film lithium niobate trioxide (LiNbO3), bulk or waveguide LiNbO3, periodically poled LiNbO3, silicon nitride in glass, doped glass, silicon carbide (SiC), polymers and/or other suitable materials. In some implementations, the optical chips 110 and 120 have ridges 112 and 122. The optical chips 110 and 120 include optical chips and waveguides, including a first waveguide in the first optical chip 110 and a second waveguide in the second optical chip 120, which are not shown in FIG. 1 for simplicity.

In order to achieve a polarization rotation between (e.g., of the electric field of the electromagnetic waves) the first waveguide and the second waveguide, the second chip 120 is placed on its edge so that the second waveguide is perpendicular with respect to the first waveguide. In some implementations, an optical coupling medium (e.g., a lens, a butt joint or a photonic wire bonding) is formed in the gap 115 between the first optical chip 110 and the second optical chip 120. In some implementations, the optical coupling medium does not change the polarization of the optical waves (light) passing through it. However, due to the rotation (90 degrees) of the second waveguide relative to the first waveguide, the polarization of the light as sensed by the second waveguide is rotated relative to the polarization of the light transmitted by the coupling medium.

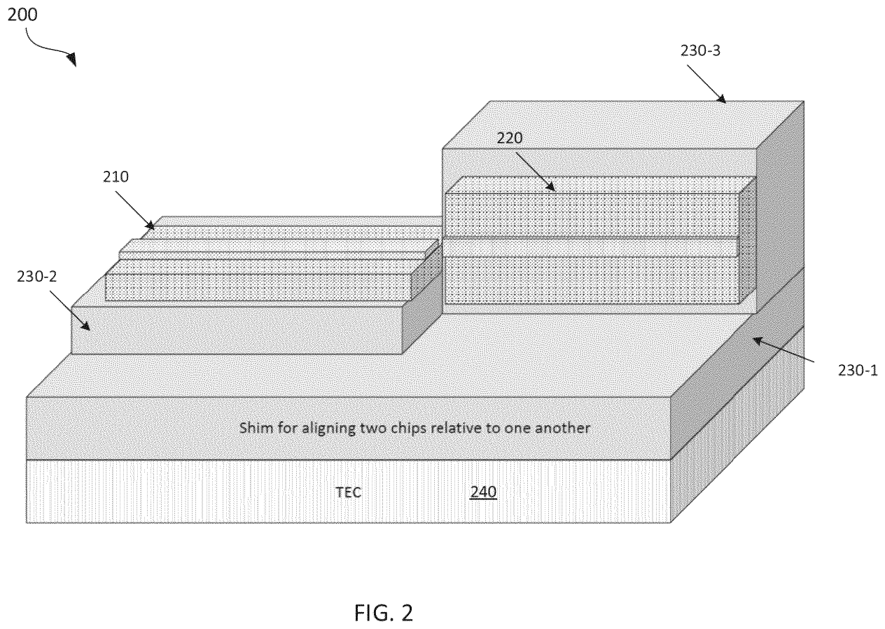

FIG. 2 is a schematic diagram illustrating an example of a setup 200 for coupling two optical chips 210 and 220 with polarization rotation, according to certain aspects of the disclosure. The setup 200 includes a first optical chip 210 and a second optical chip 220, both of which include associated waveguides. The first optical chip 210 and a second optical chips 220 are assembled on a shim consisting of three parts 230-1, 230-2 and 230-3. In some implementations, the shim is a monolithic piece made by machining a piece of metal to form the three parts 230-1, 230-2 and 230-3 out of the piece of metal. In some implementations, the metal can be aluminum nitride (AlN), silicon carbide (SiC), Kovar or other similar metals. In one or mode implementations, the parts 230-1, 230-2 and 230-3 are made separately and used to construct the shim as shown by FIG. 2. The part 230-1 is a substrate part, on which the parts 230-2 and 230-3 are placed. The geometry of the parts 230-2 and 230-3 are chosen based on the dimensions of the first optical chip 210 and the second optical chip 220 and are used to align the waveguides and secure the optical chips in place.

The first optical chip 210 is attached to the first surface of the part 230-2, and the second optical chip 220 is attached to the first surface of the part 230-3, which is perpendicular to the first surface of the part 230-2. The setup 200, therefore, enables the associated waveguides of the first optical chip 210 and the second optical chip 220 to sense polarizations that are rotated by 90 degrees with respect to one another.

In some implementations, the substrate part 230-1 is mounted on a TEC layer that can be used to control and maintain the temperature of the first chip 210 and the second optical chip 220 in order to have more stable performance.

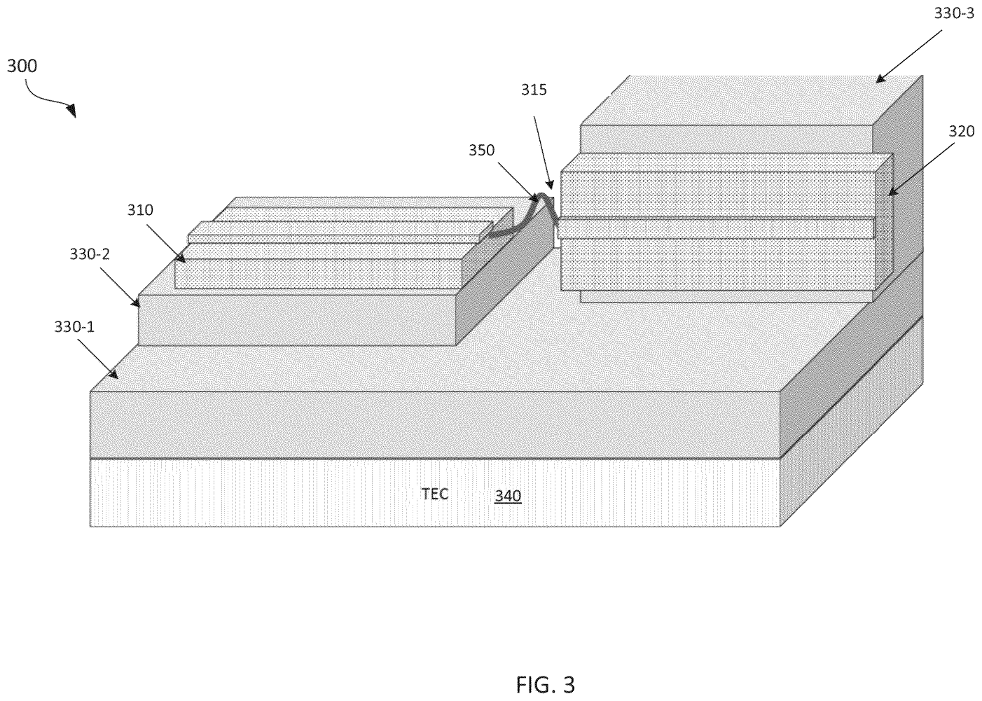

FIG. 3 is a schematic diagram illustrating an example of a setup 300 for coupling, via a PWB 350, two optical chips 310 and 320 with polarization rotation, according to certain aspects of the disclosure. The structure of the setup 300 is similar to the setup 200 of FIG. 2, except that the gap 315 (e.g., within a range of about 150-300 μm) between the two optical chips 310 and 320 and the PWB 350 are shown. The optical chips 310 and 320 are mounted on shim parts 330-1 and 330-3, and shim part 330-1 is mounted on a TEC 340. The PWB 350 is just used as an optical coupler between the respective first waveguide and the second waveguide (not shown for simplicity) of the optical chips 310 and 320. The PWB 350, in the embodiment of setup 300, has no role in polarization rotation, which is implemented by the perpendicular mounting configuration of the optical chips 310 and 320. The PWB 350 is fabricated by a photolithographic and etch process performed by using a photonic wire-bonding probe using two polymers for the material of the core and cladding of the PWB. It should be noted that the bending of the PWB 350 is exaggerated in FIG. 3 and in practice is not needed to be that much.

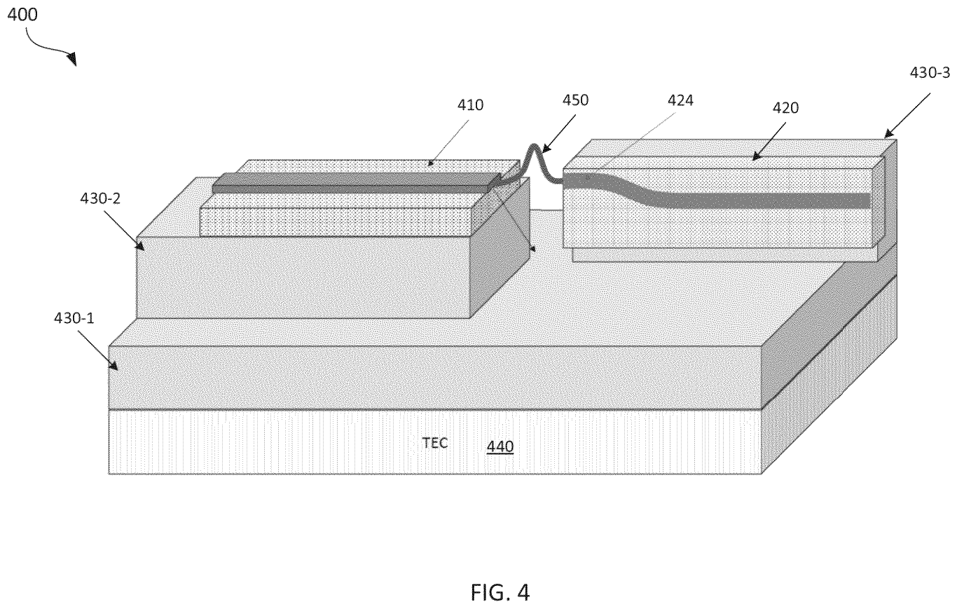

FIG. 4 is a schematic diagram illustrating an example of a setup 400 for coupling, via a PWB 450, two optical chips 410 and 420 with polarization rotation, according to certain aspects of the disclosure. The structure of the setup 400 is similar to the setup 300 of FIG. 3, except that the waveguide 424 of the optical chips 410 and 420 is revealed to show a curve in the structure of the waveguide 424. The shim parts 430-1, 430-2 and 430-3 and the TEC 440 are similar to the corresponding components in setup 300. The curve in the waveguide 424 allows the waveguide 424 to end near an edge of the optical chips 420. The bending of the PWB 450 is exaggerated in FIG. 4 and in practice is not needed to be that much.

In some implementations, the waveguide 424 can be a straight waveguide close to the edge of the optical chip 420 or an angled waveguide such that the output at the side of the optical chip 420 that is to be connected to the PWB 450 is close to the edge of optical chip 420. This is to ensure the 2-photon process can get in close to the waveguide 424 and/or a facet. If the waveguide 424 is too far down from the top surface of the optical chip 420, the lens used for the waveguide writing can bump into the optical chip 420.

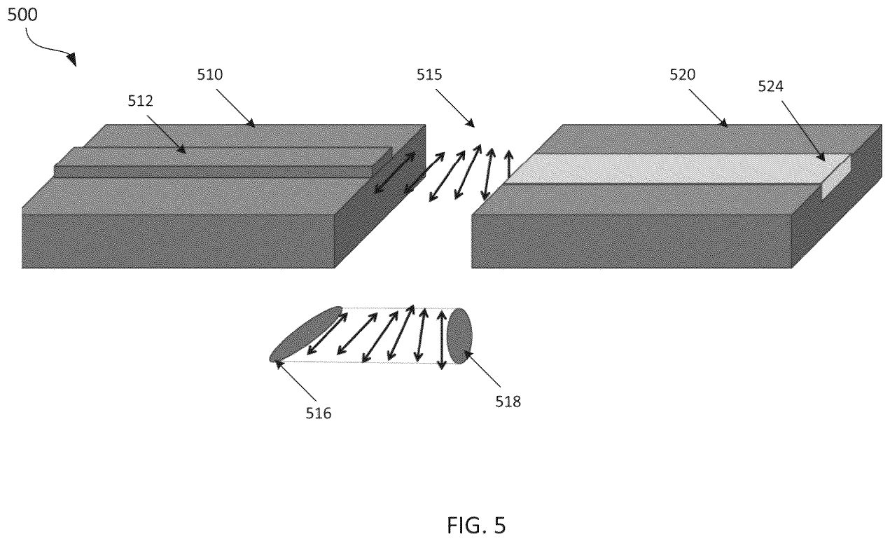

FIG. 5 is a schematic diagram illustrating an example of a setup 500 for a coupling 515 between two optical chips 510 and 520 using a PWB to achieve polarization rotation, according to certain aspects of the disclosure. The optical chips 510 and 520 include ridges 512 and 524, which can be built raised (as in 512) or inside the chip (as in 524). The optical chips 510 and 520 are mounted and aligned on the same plane and the polarization rotation is performed by the PWB, which is used to optically couple the optical chips 510 and 520. The PWB is made flexible and with an oval cross-section. The flexibility allows to have oval-shaped cross-sections 516 and 518 of the PWB at places of the connection to the optical chips 510 and 520 be perpendicular to one another. This configuration enables polarization rotation (e.g., by 90 degrees) to be achieved when the light is transmitted through the PWB. In some implementations, the polarization rotation can be performed by a PWB with a tailored shape (e.g., asymmetric with attention to the path length) or possibly by rotating the oval. Also, before and after the polarization rotation a separate adiabatic mode matching can be considered.

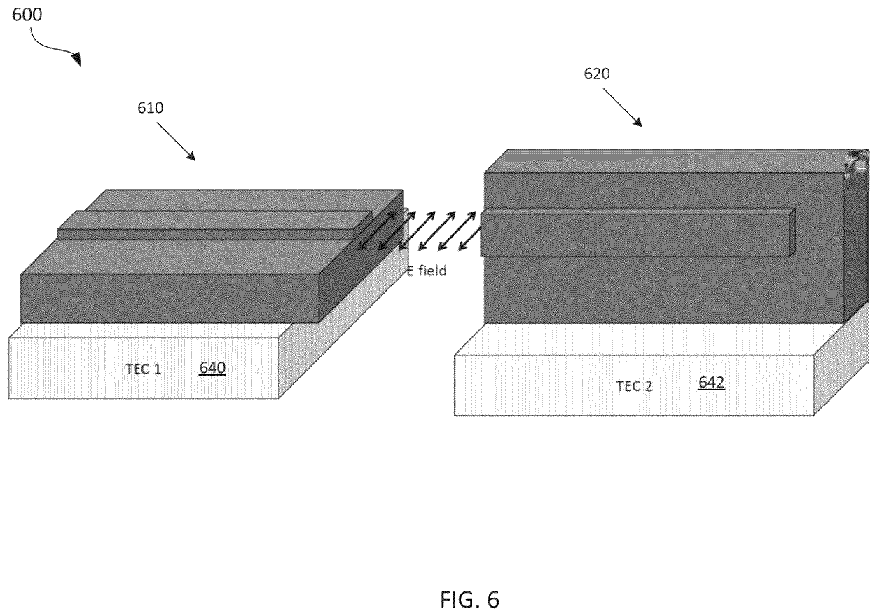

FIG. 6 is a schematic diagram illustrating an example of a setup 600 for coupling two optical chips 610 and 620 with polarization rotation with independent temperature control, according to certain aspects of the disclosure. The structure of the setup 600 is similar to the setup 300 of FIG. 3, except that PWB 350 is not shown and the TEC 340 of FIG. 3 is partitioned into two TEC 640 and 642. This allows for independent temperature control of the optical chips 610 and 620. This feature can be useful, for example, when the optical chip 610 is a DFB and the optical chip 610 is a frequency doubler and the temperature tuning can help with wavelength matching. In some implementations, one or more thermistors may be used to monitor the temperature for the TEC 640 and 642 to control the temperature.

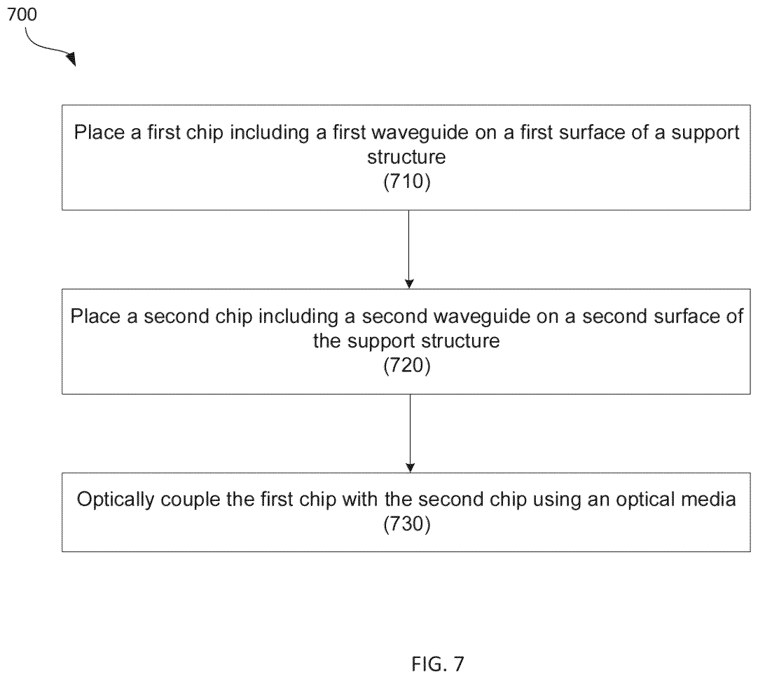

FIG. 7 is a schematic diagram illustrating an example of a method 700 of configuring an arrangement of two optical chips to enable polarization rotation, according to certain aspects of the disclosure. The method 700 consists of placing a first chip including a first waveguide on a first surface of a support structure (710) and placing a second chip including a second waveguide on a second surface of the support structure (720). The method further includes optically coupling the first chip with the second chip using an optical medium (730). A first electric field of electromagnetic waves within the first waveguide has a first polarization and a second electric field of the electromagnetic waves within the second waveguide has a second polarization rotated with respect to the first polarization.

Aspects of the subject matter described in this disclosure can be implemented to realize one or more of the following potential advantages. The described techniques may be implemented to support a range of benefits and significant advantages, for example, achieving polarization rotation between two optical chips when optically coupled via a medium such as PWB, using a robust and stable setup.

A significant aspect of the disclosed technology includes mitigating the limitations associated with connecting waveguides and effectively managing polarization changes within optical systems (e.g., chips).

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the terms “include,” “have,” or the like is used in the description or the claims, such term is intended to be inclusive in a manner similar to the term “comprise” as “comprise” is interpreted when employed as a transitional word in a claim. The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Other variations are within the scope of the following claims.

What is claimed is:

1. An apparatus, comprising:
a first chip including a first waveguide;
a second chip including a second waveguide; and
a medium configured to couple the first waveguide with the second waveguide,
wherein a first plane of the first chip is configured to be perpendicular to a second plane of the second chip to enable a polarization rotation.

2. The apparatus of claim 1, wherein the polarization rotation comprises a 90-degree rotation of a second electric field of electromagnetic waves within the second waveguide relative to a first electrical field of the electromagnetic waves within the first waveguide.

3. The apparatus of claim 1, wherein the medium comprises an optical wire bond configured to conserve a first polarization within the first waveguide.

4. The apparatus of claim 1, wherein the first chip comprises a first semiconductor chip including a first optical circuit and the second chip comprises a second semiconductor chip including a second optical circuit.

5. The apparatus of claim 4, wherein the medium is configured to couple the first optical circuit with the second optical circuit.

6. The apparatus of claim 1, wherein the first waveguide and the second waveguide are supported by using an alignment shim.

7. The apparatus of claim 6, wherein the alignment shim comprises a first surface perpendicular to a second surface.

8. The apparatus of claim 7, wherein the first chip and the second chip are attached to the first surface and the second surface of the alignment shim, respectively.

9. The apparatus of claim 1, further comprising a thermistor configured to measure a temperature of the first chip and the second chip and a thermoelectric-cooler (TEC) layer configured to control the temperature of the first chip and the second chip.

10. The apparatus of claim 1, further comprising a first TEC layer and a second TEC layer configured to control temperatures of the first chip and the second chip, independently.

11. An apparatus, comprising:
a first chip including a first waveguide;
a second chip including a second waveguide; and
an optical wire bond configured to couple the first waveguide with the second waveguide,
wherein:
the first chip is placed on a first surface of a support structure,
the second chip is placed on a second surface of the support structure, and
a first electric field of electromagnetic waves within the first waveguide has a different polarization than a second electric field of the electromagnetic waves within the second waveguide.

12. The apparatus of claim 11, wherein a second polarization of the second electric field of the electromagnetic waves is rotated with respect to a first polarization of the first waveguide by 90 degrees.

13. The apparatus of claim 11, wherein the first surface and the second surface of the support structure are configured to be perpendicular to one another to allow a 90-degree polarization rotation.

14. The apparatus of claim 11, wherein the first surface and the second surface of the support structure are configured to be on a same plane.

15. The apparatus of claim 14, wherein a polarization rotation between the first electric field of the electromagnetic waves and the second electric field of the electromagnetic waves is enabled by the optical wire bond.

16. The apparatus of claim 11, further comprising a TEC layer configured to control temperatures of the first chip and the second chip.

17. The apparatus of claim 11, further comprising a first TEC layer and a second TEC layer configured to control temperatures of the first chip and the second chip, independently.

18. A method, comprising:
placing a first chip including a first waveguide on a first surface of a support structure;
placing a second chip including a second waveguide on a second surface of the support structure; and
optically coupling the first chip with the second chip using an optical medium,
wherein:
a first electric field of electromagnetic waves within the first waveguide has a first polarization, and
a second electric field of the electromagnetic waves within the second waveguide has a second polarization rotated with respect to the first polarization.

19. The method of claim 18, wherein a polarization rotation associated with the second electric field of the electromagnetic waves with respect to the first electric field of the electromagnetic waves is achieved via the optical medium, and wherein the optical medium comprises an optical wire bond.

20. The method of claim 18, wherein a polarization rotation associated with the second electric field of the electromagnetic waves with respect to the first electric field of the electromagnetic waves is achieved by the second surface being perpendicular to the first surface.
